(19) United States
(12) Patent Application Publication
(10) Pub. No.: US 2009/0083653 A1
(43) Pub. Date: Mar. 26, 2009

(54) System for facilitating remote digital image manipulation services

(76) Inventors: Jeffrey T. Makoff, Tiburon, CA (US); Charlotte N. Makoff, Tiburon, CA (US); Barnabas Takacs, Los Angeles, CA (US); Aaron J. Daru, San Francisco, CA (US)

Correspondence Address: STALLMAN & POLLOCK LLP, 353 SACRAMENTO STREET, SUITE 2200, SAN FRANCISCO, CA, 94111, US

(21) Appl. No.: 12/214,418

(22) Filed: Jun. 18, 2008

Related U.S. Application Data
(62) Division of application No. 09/865,113, filed on May 24, 2001, now abandoned.
(60) Provisional application No. 60/213,690, filed on Jun. 23, 2000.
(60) Provisional application No. 60/246,938, filed on Nov. 10, 2000.
(60) Provisional application No. 60/278,870, filed on Mar. 26, 2001.

(51) Int. Cl. G06F 3/048

(52) U.S. Cl. 715/780

(57) ABSTRACT

An integrated interface is disclosed which facilitates combining digital images and instructions for modifying those images. This information can be electronically transmitted over a network to a remote Editor or Artist capable of modifying the image in accordance with the instructions. In one version, the interface includes relatively sophisticated marking tools which allow the image holder to input very accurate and detailed image manipulation instructions. An alternative interface is disclosed which is less complex and directed to the consumer market. A system is also disclosed for pricing the image modifications and for selecting and routing the work to various Editors in remote locations.

### PRIORITY

This application is a divisional of U.S. application Ser. No. 09/865,113 filed May 24, 2001. This application claims priority from prior provisional application Ser. Nos. 60/213,690 filed Jun. 23, 2000; 60/246,938 filed, Nov. 10, 2000, and 06/278,870, filed Mar. 26, 2001.

### TECHNICAL FIELD

The subject invention relates generally to digital imaging technology. In particular, the invention relates to facilitating the transfer of images and associated instructions for modifying those images to remotely located persons (“Editors” or “Digital Editors”) who specialize in digital image manipulation.

### BACKGROUND OF THE INVENTION

In the past 10 years, a migration has occurred from conventional photographic processes to digital technologies. Digital images may be edited, using digital image manipulation tools, to a far greater extent than “analog” (generally silver halide) images could be retouched. The editing of digital images can, and often does, involve the integration of entirely new images, or even non-photographic images into composite or “multi-layer” images.

The basic digital image editing technology is a computer and a program that facilitates image editing. Different creative and technical skills are required for image capture (the Photographer) than for editing that image. Accordingly, the finishing of a digital photograph for both commercial and private purposes often requires collaborative work by more than one individual, often working in more than one physical location.

The availability of large computer networks, with file transfer capabilities, makes it possible to have the digital image capture and image editing done in geographically remote locations. This can produce economic efficiencies, because image editing work may be done by people at skill and compensation levels unavailable in a geographically-proximate place to the photographer who captured the image, the person who has creative discretion over changes or other person who is involved in the chain of digital image production. Remote collaborative commerce is made difficult, however, by the absence of a common technology platform and standard process through which the parties may act.

### SUMMARY OF THE INVENTIONS

The ability to transfer digital images from one location to another creates the opportunity to address a variety of different needs that currently are not being adequately addressed.

One area of interest is the professional photographic market. Every day, magazines are distributed with hundreds of photographic images, particularly advertising images. These images are initially created by a Photographer and then edited by a Digital Image Editor to remove blemishes, change lighting, fix technical flaws and implement other enhancements for accuracy and/or visual effect. Due to logistical factors, under the current practice the Editors selected to perform the work typically are geographically proximate to the photographer. The subject invention provides a platform to facilitate the services of Editors located anywhere in the world.

In this aspect of the subject invention, a user interface is provided for the Photographer or other instructing person to enter instructions regarding desired modifications of a digital image. The interface displays an array of conventional editing instructions and drawing tools to allow the Photographer to accurately give specific instructions to the Editor. This information along with the digital image can then be sent to an Editor over a network (e.g., the Internet) anywhere in the world. The Editor can carry out the instructions and send back the modified image to the Photographer or other recipient.

In the above description, it is assumed that the Photographer knows of and selects the Editor—using the subject invention to facilitate communication of the editing instructions. This use of the invention can be expanded to include an approach where a central Provider exists and acts as a conduit between many Photographers and many Digital Editors. As discussed in more detail below, it is envisioned that such a central Provider would establish relationships with groups of Digital Editors throughout the world and manage the technology, workflow, business aspects and quality control.

Under the expanded approach, photographers would send digital images and instructions for modification to the central Provider. It would then be the responsibility of the Provider to select the appropriate Editors to perform the work. The selection criteria can include pricing, availability of the Editors, the complexity of the work in relation to the skills of the Editors and other factors in the time-quality-cost paradigm. Because the Provider can select Editors working in geographical regions with lower overhead, cost savings can be achieved when doing work for Photographers located in geographical regions with high overhead. In addition, the Provider can generate profits if it can obtain the services of the Editors at a cost lower than Photographers are willing to pay the Provider.

The same broad concepts also can be translated into a digital editing product for consumers. Even amateur photographers occasionally desire to enhance a picture they have taken. A precious family photograph, for example, may be worthy of enlargement and display if only a shadow had not fallen over a loved-one's face. Relatively minor modifications such as color correction or digital removal of an untimely blemish can turn a disappointing photograph into a keepsake. While various do-it-yourself digital editing tools are available, it is beyond the capability of most consumers to perform edits of even modest difficulty.

Professionally-executed digital editing services are not usually available at a reasonable cost in the areas in which they need to be preformed. The systems of the subject invention provide a unique platform to deliver such services at a reasonable cost. In this aspect of the subject invention, the Consumer would be provided with a simplified interface for entering digital image editing instructions. It is within the scope of the subject invention, however, that features described below with respect to the professional interface could be used with the consumer interface and vice versa. Under the expanded approach, using the interface the Customer (User) enters the instructions for modification of the image. The User then transmits the instructions and the digital image to a Provider over a network. The Provider would then generate a cost estimate of the project. This could be done algorithmically based on the nature of the modifications requested. If the User accepted the proposed price, then the Provider would arrange for an Editor to do the work. As noted above, the Editors may be located remote from both the User and the Provider. All communications can be over a network connections such as the internet. Once the work is done, the image would be transmitted back to the Customer. In the preferred embodiment, the Provider may review the edits prior to transmission back for quality control.

The interfaces discussed above may be used for more than just image manipulation purposes. More specifically, the user interface, particularly the professional interface, will facilitate communication and collaboration between remote parties in other applications. For example, consider a product design center operating at a location remote from a third party (manager) who needs to comment upon or order changes to a proposed design. The design team can send a digital image to the manager of the proposed design. Then the manager could make suggested changes using the interface. For example, the manager could suggest shape or color changes using the interface tools. These suggested changes are then transmitted back to the Artist for execution at the design center.

In a variation on this concept, the subject interface can also be used to aid the design of a three-dimensional product. In this case, an image capturer (photographer or otherwise) can take a digital photograph of the three-dimensional prototype (workpiece) and transmit that digital photograph to the manager. The manager can make suggested changes to the product by annotating the digital image using the interface tools. These instructions would be transmitted returned to a fabricator. Rather than manipulating the digital image based on the instructions (as was the case in the previous embodiments) the fabricator would modify the actual workpiece based on the manager's instructions. Of course, this process could be repeated until the design of the workpiece was acceptable to the manager.

Further objects and advantages of the subject invention will become apparent from the following detailed description, taken in conjunction with the included drawings in which:

### BRIEF DESCRIPTION OF THE DRAWINGS

FIG. 1 is an illustration of a preferred form of an interface for professional users.

FIG. 2 is an illustration of a preferred form of an interface for consumers.

FIG. 3 is an illustration of an instruction page for consumer use.

FIG. 4 is a flow chart of the operation of the professional system.

FIG. 5 illustrates the home page for the professional system.

FIG. 6 illustrates the new order page for the professional system.

FIG. 7 illustrates an interface to facilitate the uploading of digital files in the professional system.

FIG. 8 illustrates the interface to support pricing of projects in the professional system.

FIG. 9 illustrates an approval interface in the professional system.

FIG. 10 illustrates an interface designed to facilitate the delivery of images in the professional system.

FIG. 11 illustrates a status check interface in the professional system.

FIG. 12 illustrates an interface containing summary information about the Customer's order in the professional system.

FIG. 13 is a flow diagram of the consumer system.

FIG. 14 illustrates a price quote interface for the consumer system.

FIG. 15 illustrates an order status page for the consumer system.

FIG. 16 illustrates an interface, which informs the Customer of the completion of the project for use with the consumer system.

FIG. 17 illustrates an interface, which allows a Customer to add additional instructions in the consumer system.

FIG. 18 illustrates a page used by the Provider for pricing jobs in the consumer system.

FIG. 19 illustrates an interface used by an Editor to transmit final image files to the Provider in the consumer system.

FIG. 20 illustrates an interface used by the Provider to update system variables in the consumer system.

FIG. 21 illustrates an interface allowing a Customer to order prints of the edited images in the consumer system.

FIG. 22 illustrates a color palette used specify colors and can be used in either system.

FIG. 23 illustrates a photo-illustration procedure available in the consumer system.

FIG. 24 illustrates an alternate embodiment of the main interface for the consumer system.

FIG. 25 illustrates an interface that allows selection from a list of editing procedures used in the alternate embodiment of the consumer system.

FIG. 26 illustrates an interface used by the Customer to provide editing instructions in the alternate embodiment of the consumer system.

FIG. 27 illustrates an order review page used in the alternate embodiment of the consumer system.

### DETAILED DESCRIPTION OF THE PREFERRED EMBODIMENTS

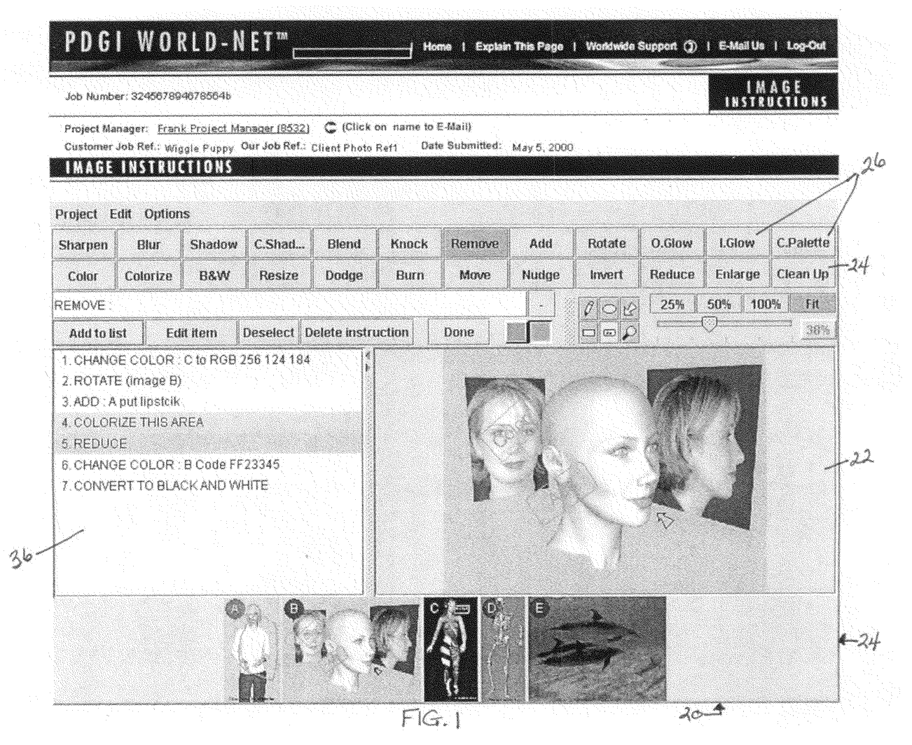

Turning to FIG. 1, there is an illustration of the primary interface 20 that permits professional users to input instructions for modifying an image. The interface includes a region 22 for displaying a reduced size version of the image. The interface typically displays the image at a resolution less than the resolution of the original image file submitted by the Customer.

The interface also includes a first tool bar 24 with a selection of action buttons 26 representing typical editing instructions such as sharpen, blur, dodge, burn, etc. These buttons can be selected in a typical manner such as by a mouse click. If the instruction is to be applied to a portion of the image, the User can enable a drawing tool. Selection of the drawing tools can be made from display 30. Drawing tools can include such items as an electronic pencil, a stamp, an arrow and a boundary marker. The drawing tool can be used to identify (i.e., by pointing, stamping, circling, “x”-ing, etc.) the region of the image to be manipulated. An image pointer will be generated and overlaid on the digital image. This pointer 32 will be logically connected to the instruction. Thus, if the Editor were to click on instruction 3 “add lipstick” the associated pointer will be identified (i.e., by a change in appearance), so that the location of the instruction will be unambiguously identified to the Editor.

The interface further includes a region 36 for adding textual instructions. The textual instructions can be associated with one of the editing buttons 26 or be an independent instruction.

In the preferred embodiment, additional aids are provided. For example, region 38 includes a slider bar and buttons for more easily controlling gradation changes, including size, brightness, etc. In addition, a color palette can be provided so that the desired color change can be unambiguously defined.

The active buttons 26 in the tool bar 24 are fully configurable from a database. In this manner, the interface and the instructions themselves can be updated or modified as needed to permit the changing needs of the Customers and Editors. This flexibility will also allow the system to be more easily adapted to other applications.

In the preferred embodiment, the buttons 26 reflect an effort to standardize the instruction set for the editing process. Some standardization is required to reduce the ambiguity associated with communicating instructions. This standardization also makes it possible to implement algorithmic pricing and simplify the estimate of resources (people, skill set and time) needed to execute the job.

The preferred interface further includes a panel where thumbnails of the various digital images are displayed. The User can toggle through the pictures and instruction set. These images are each associated with specific instructions in a drag and drop fashion. For example, the user can drag image “A” from row 42 to the main display area 22 to tie the instruction set to the image. The instruction set can be retained while adding or removing images. In this manner, similar instructions can also be associated with multiple images.

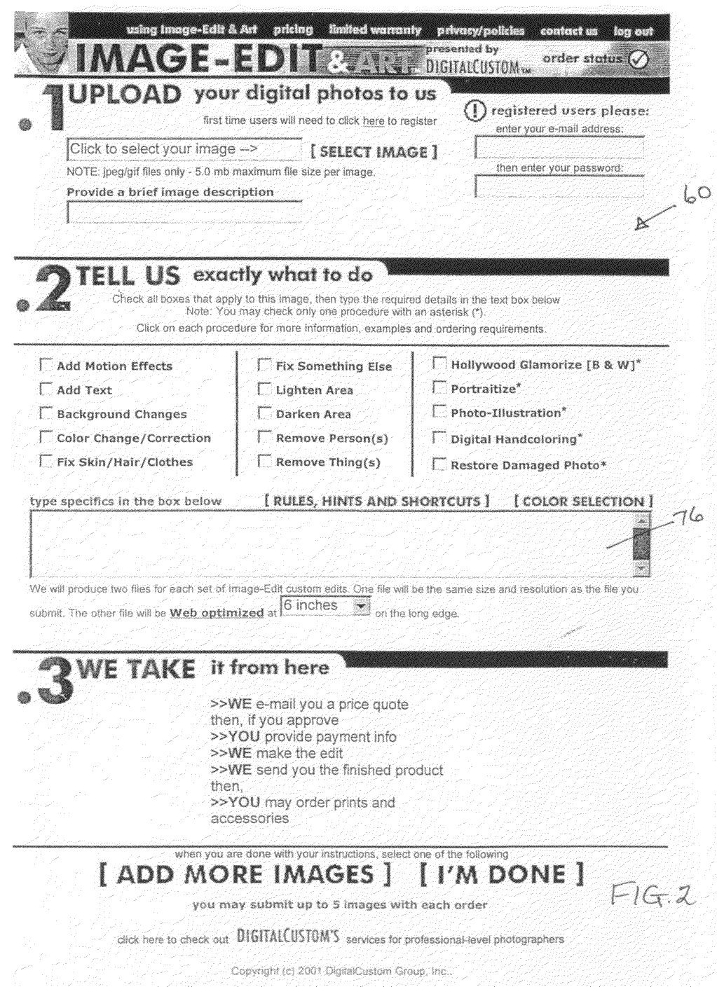

FIG. 2 is an illustration of a first embodiment of an interface 60 that is more suitable for the non-professional consumer market. This interface is intended to be easier to use, but of course would not permit the level of precise, targeted changes available with interface 20. Interface 20 includes a first region 62 for logging into the system. A second region 64 facilitates attachment of a digital image. The approach used is a standard “browse” feature for searching memory (hard drive, floppy, network, etc.) linked to the User's processor.

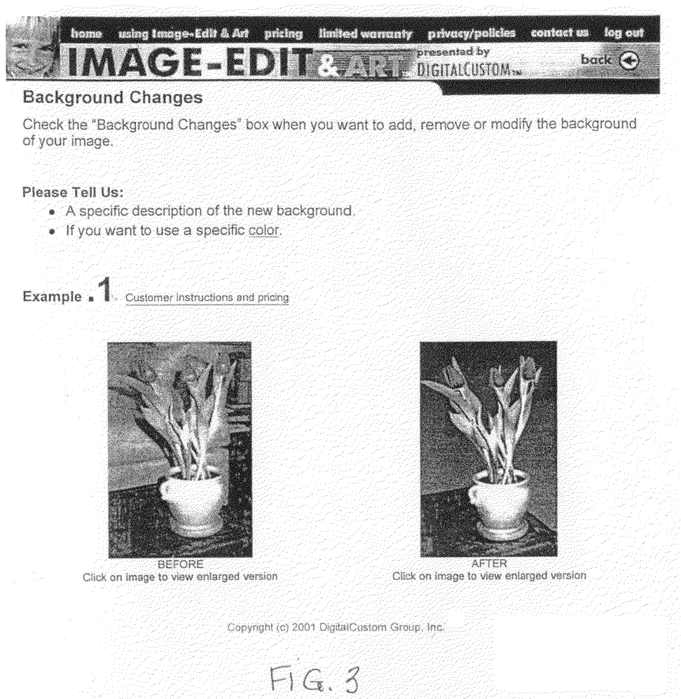

A third region 66 provides a selectable list common edit instructions, such as “add text”, “fix skin”, “lighten area”, etc. Many of these instructions are themselves linked to further information about the instruction. For example, if a User were to click on the phrase “background changes” (as opposed to clicking on the box to the left of background changes) the User would be taken to another page describing the feature and showing an example of the proposed change. FIG. 3 is an example of an instruction page. As can be seen, in the original digital image, the corner of a couch 70 is seen behind the plant 72. In the modified image, the couch has been removed.

The interface further includes a region 76 where the User can manually enter typed instructions to amplify and explain in more detail the type of edit which is desired. In the instructions pages such as shown in FIG. 3, helpful hints are provided to aid the User in drafting his instructions so they will be more easily understood by the Artist.

The interfaces 20 and 60 described above provide a platform for accurately communicating to a remote digital Editor the desired changes in an image. As noted above, although two different interfaces have been disclosed for two different applications, various features of either could be interchanged to suit a particular application. Further, the names “professional” and “consumer” are selected merely for ease of description and are not intended to be limiting to a particular market segment.

Having described the basic interfaces, implementation of the methodologies for carrying out the process will now be discussed.

### Professional Version

This version of the subject invention is intended to allow digital Editors in remote locations to participate in the business of modifying images taken by Photographers in other geographic areas. There is no relationship between the typical geographical locations where photographs are created and the geographical locations where they can be edited. Today, there are regions in many countries that might be considered “underdeveloped” that have small, but thriving technology and creative centers. The tools for editing digital images are widely available and operate on standard computer platforms. It is envisioned that a central Provider will be responsible for locating and training these remote Editors on the needs and requirements of Customers (photographers, advertising agencies). Acting as an intermediary, the Provider can distribute work, pay the Editors, manage quality control and collect fees for editing services.

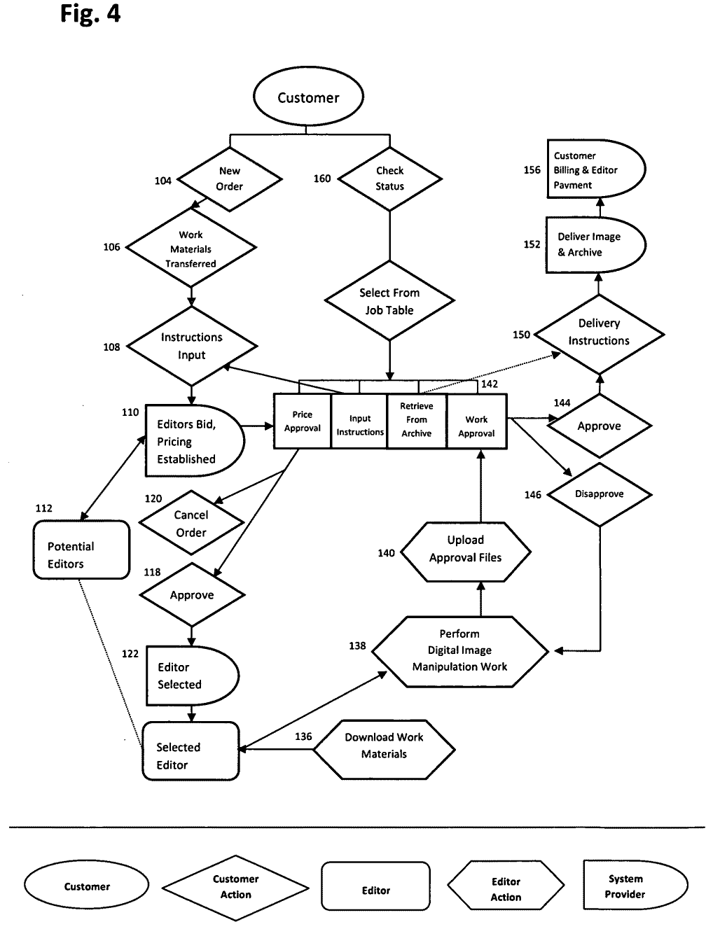

FIG. 4 is a flow diagram of one preferred approach for carrying out the subject invention. The order begins by validating the Customer's access. The Customer initially accesses the system using a computer, connected to a wide-area network (which may include, but is not limited to, what is commonly known as the “Internet”). Once the Customer's identity and right to access the system have been validated, the Customer may initiate a “new order” for digital image manipulation (step 104). In step 106, new order materials are identified and transferred. In this step, the Customer electronically transfers to the Provider any digital materials for the order (which would include, inter alia images that are required to complete the desired manipulation, as well as any examples, editorial, and collateral materials). The transferred order materials are associated with a unique identifying tag (the “Provider Tag”) that is generated by the system once materials are transferred. The Customer may assign its own reference to the order (the “Customer Tag”), which is associated by the system with the system-generated Provider Tag. The commencement of the file transfer process updates a database and database-generated “Order Status” display for the Provider and Customer to indicate an “Upload In Progress” with respect to the order identified by the Provider Tag and Customer Tag. For each uploaded image, a version optimized for efficient network transmission and display on then-available machine display technology is generated. The optimized and non-optimized images are stored electronically at a database location that is associated with the Provider Tag.

In step 108, the Customer inputs digital image manipulation instructions using both written and graphical instructions with the interface discussed above. More particularly, the written instructions are inputted using a “Text Instruction Compiler” method and process: The “Text Instruction Compiler” is a machine-generated compilation through which a Customer (or other instruction-giver) designates specific digital image manipulation instructions that an Editor is required to perform on a subject image. An instruction is entered into the “Text Instruction Compiler” when the Customer selects a button for an associated, predefined instruction, types a custom instruction into an instruction line, or enters a combination of a predefined instruction and supplemental typewritten instructions. The system generates an ordered text list that correlates with the Customer's selections and manually entered instructions, the related files.

The graphical instructions are inputted using the “Graphical Instruction Compiler” method and process. As noted above, this module allows the Customer (or other instruction-giver) to indicate instructions (which may or may not be supplemental to text instructions) graphically by “drawing” on a rendered version of a subject image. The Customer first selects a “pencil” or other electronic stylus (such as a cropper, or circle drawer). The Customer then uses the stylus to draw one or more superimposed electronic instructions (which may include diagrams) over the rendered subject image. The superimposed instructions become part of what is rendered on the display screen, and are juxtaposed with the “Text Instruction Compiler” instructions, to create complete textual/graphical instructions.

The completion of the order instruction process updates a database and database-generated “Order Status” display for the Provider and Customer to indicate “In Pricing” with respect to the order identified by the Provider Tag and the Customer Tag. The system organizes and prioritizes the instructions in an enumerated list according to principles of efficiency that are pre-programmed into the system. The system can generate an instruction summary in a display language (such as Hypertext Markup Language) containing all written and graphical instructions.

In step 110, the system recommends the Editors who are “best” to fullfill the order requirements. The selected Editors are determined by: (1) matching the skill and experience level of Editors with the skill and experience implied by the Customer's instructions, (2) considering Editors who provide service at a quality and price level that is consistent with the Customer's industry and expectations, and considering (3) the order deadline and the Editor's workload. The Provider selects an appropriate subset of Editors to bid on the order (step 112). Alternatively, the Provider allows the system to select the Editor subset.

The system advises the selected Editors that an order is available for a bid or price quote through one of several possible methods, which has been selected by the Provider including but not limited to: (1) Request for Quote (Editors are asked for a price quote, Provider selects); (2) Low-Bid (Editors are asked for a bid, system selects lowest bidder); (3) First-to-Grab (Provider designates a price for the order, first Editor to accept is awarded the order); or (4) Yours-To-Lose (Provider offers order to a specific Editor at a specific price, Editor accepts or declines. Decline results in a further procedure).

Each participating Editor enters his pricing information into the system. Depending on the process selected by the Provider, either the system awards the order, or the Provider awards the order, to the prevailing Editor. The non-selected Editors are notified that they were not selected. The system generates a suggested price matrix for the Customer's order, based upon a “standard markup” varying with delivery time. Completion of the pricing matrix updates a database and database-generated “Order Status” display for the Provider and Customer to indicate that “Customer Price Approval” is awaited for the order identified by the Provider Tag and the Customer Tag. The system alerts the Customer that a price quote is available.

The Customer can accept one of the price/delivery time combinations and continue (step 118), or cancel the order and the order process is immediately terminated (step 120). If the Customer accepts, the selected Editor is alerted to proceed with digital image editing work, in accordance with the order instructions, according to the designated delivery time in step 122.

The instruction for the Editor to commence digital image editing updates a database and database-generated “Order Status” display for the Provider and Customer to indicate that the order is “With Creative Department”. The selected Editor is given electronic access to all project materials and may download the materials required for the job. The selected Editor downloads the materials and is sent any non-digital materials (step 136). The Editor performs the requested services according to the instruction interface (step 138).

Once the work is completed, the selected Editor will upload approval versions of the completed work into the system (step 140). Uploading of approval materials updates a database and database-generated “Order Status” display for the Provider and Customer to indicate that “Artwork Approval” is awaited for the order identified by the Provider Tag and the Customer Tag (step 142).

The Customer is notified that completed work is available for viewing and approval. The Customer approves (step 144) or disapproves (step 146) and gives additional comments or instructions. The Customer's approval updates a database and database-generated “Order Status” display for the Provider and Customer to indicate “Delivery Instructions Needed” for the order identified by the Provider Tag and the Customer Tag. The Customer's disapproval updates a database and database-generated “Order Status” display for the Provider and Customer to indicate that the order is back in the “Creative Department”, and the Customer is permitted to use the written and graphical instruction module to give further comments on the work. Comments on partially-completed work are directed back to the Editor who commenced the job. The Editor makes the revisions and Steps 138 and 140 are repeated until the Customer approves the work (or cancels the order).

At this stage, the Customer inputs delivery instructions (step 150). The Customer may retrieve the file over the network or elect to have the file produced and then delivered in different formats and media (i.e., file optimization for different media, color calibration for printing, etc.). The Provider delivers the image as requested by the Customer and also archives the image (step 152). The customer may retrieve the image in the future by returning to the system and locating this order in the completed images area.

A billing entry is made in the system, which considers the price and delivery-related costs. This entry ultimately is transferred to a billing and accounts receivable system. The completion of work also triggers a notice to the Editor, summarizing the project and noting the amount payable. This information ultimately is transferred to accounts payable (step 156).

At any point in the process, the Customer can log into the system and check on the status of the job at a Comprehensive Status Interface (step 160). The job status is updated as a result of certain events in the manner described above. Using the interface, Customer can view the status on active jobs and select any job for more details or to take action on a particular job (step 162).

### Further Details of the Professional Interface

Having described the overall process and the primary interface for inputting instructions, additional features of the operational interface for professional Users will be described and illustrated.

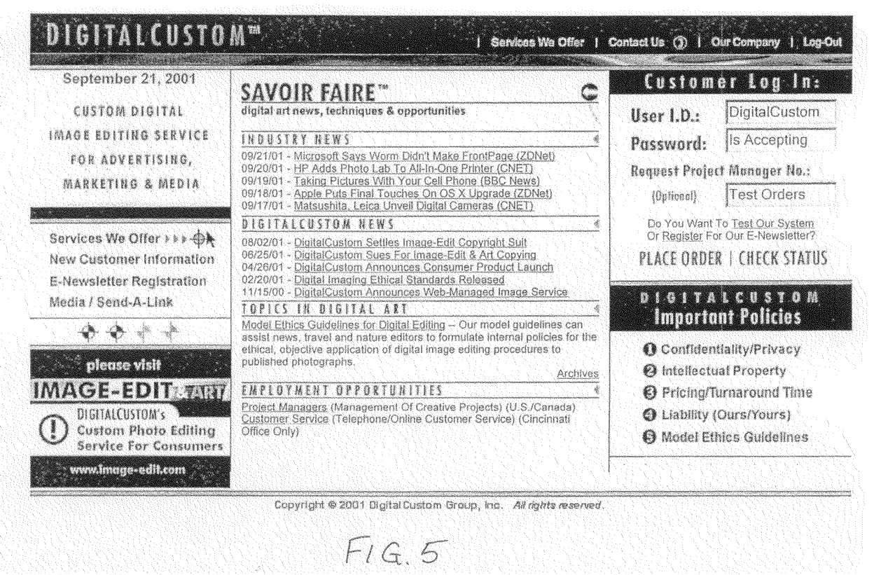

FIG. 5 illustrates the “Home” interface that gives general information about the system and includes the Customer login. The Home screen includes: the current date (system-generated); a brief description of what the system does; a hyperlink to a more detailed description of services; a hyperlink to a Customer application; a hyperlink to an electronic newsletter subscription form; a hyperlink to media contact information and a tool to send a hyperlink about the system to a third-party; hyperlinks to important policy statements; industry news; news about the system; an article about digital image manipulation; and employment opportunity listings.

The Customer login section includes Customer ID and password fields for validation purposes. Additional buttons and their actions include:

Place Order Button: Upon a valid login, initiates a new order;

Check Status Button: Upon a valid login, goes to the Comprehensive Status Interface;

Project Manager ID: Entering a valid project manager number will assign that Project Manager to all orders placed by the Customer in that session. Entering an invalid project manager ID will bring the Customer to the “Invalid Project Manager Number” interface;

Project Manager Finder: When the Customer clicks on the “here” to find a project manager the Customer is brought to the “List of Project Managers” index.

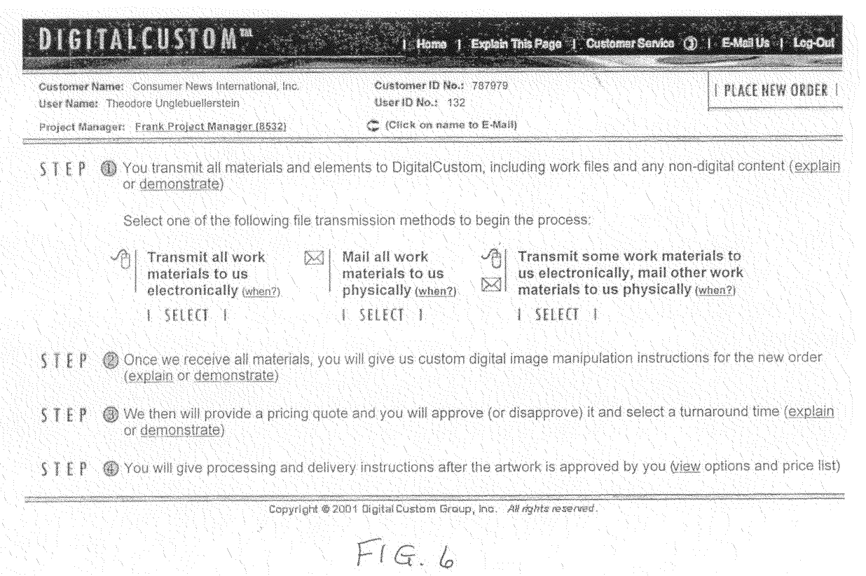

FIG. 6 is an illustration of the new order screen. This interface gives step-by-step instructions for the order process. To proceed, the Customer chooses a method to transmit project work materials to the system. Selecting “Mail all work materials to us physically” brings the Customer to the “Transmit Physical Materials” interface that gives instructions on the process to follow. Selecting “Transmit all work materials to us electronically” brings the Customer to the “Upload Files for New Project” interface, where the Customer uploads the files. Selecting the “Transmit some work materials to us electronically, mail other work materials to us physically” brings up a new window with the “Transmit Physical Materials” interface and the “Upload Files for New Project” interface in the original window.

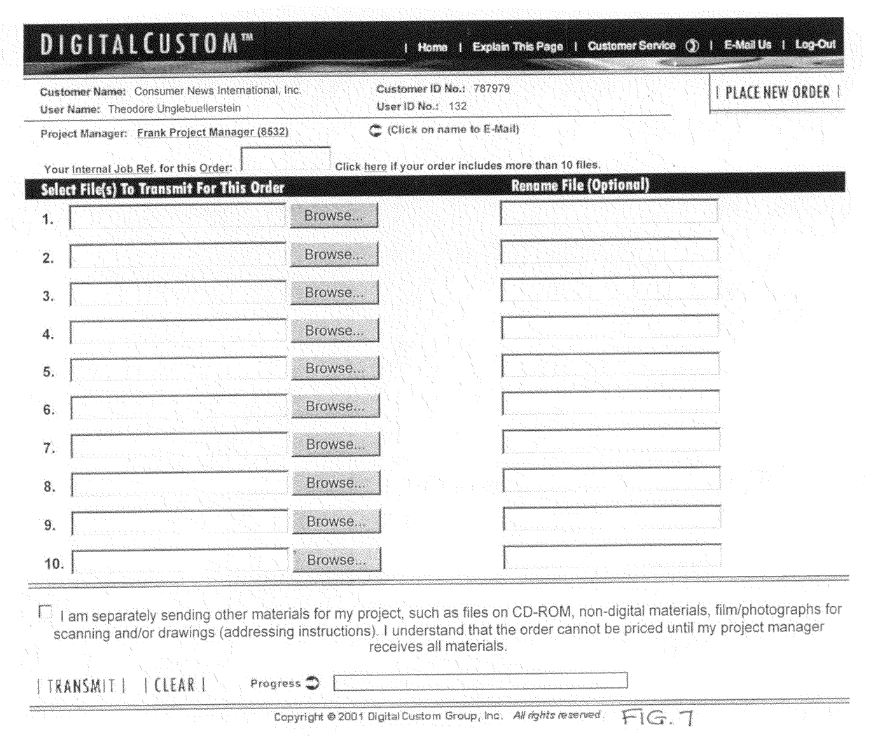

FIG. 7 is an illustration of the interface for uploading digital files to the system. The Customer can assign a new Customer-generated name to any uploaded file so it can be more easily referred to later in the process. The Customer can also add an internal order reference number to the entire order, for easy reference. If the Customer intends to rely upon physical materials, the Customer should check the corresponding box. Checking this box will bring the Customer to the “Transmit Physical Materials” Interface.

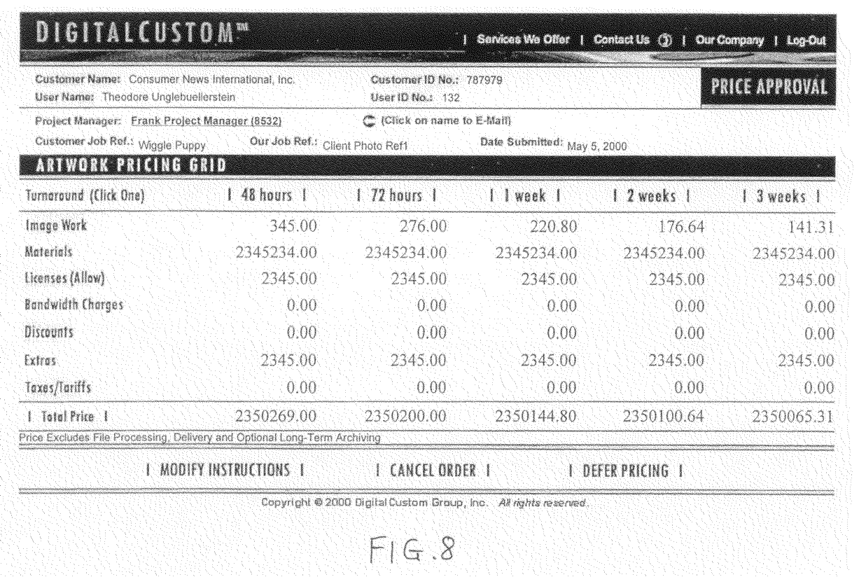

FIG. 8 illustrates the interface to support pricing of the project. The Customer can choose a price and turnaround time from the price grid or cancel the project. The price grid is generated using an algorithm with the inputs resulting from the Editor bids. After choosing a price, the Customer and Provider are alerted if the project cost will put the Customer's balance above the credit limit or within a specified percent of a credit limit.

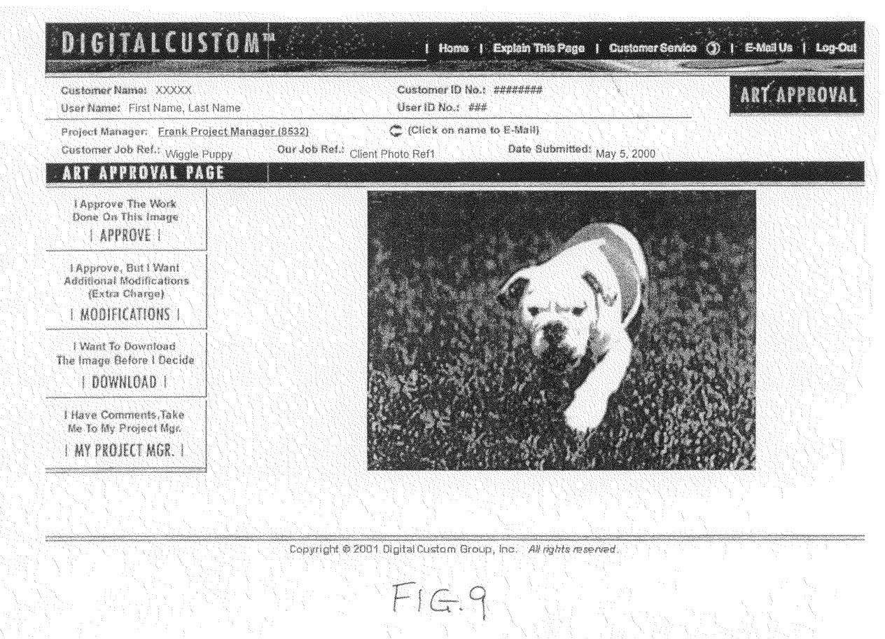

FIG. 9 is an illustration of the approval interface. The Customer can review completed digital image manipulation work on this interface. The interface displays the display optimized image(s) that are ready for review and approval. After reviewing the work, the Customer may choose from four options:

a) Approve: If the work is approved, the image work is considered complete and satisfactory and the “Project Processing and Delivery Instruction” interface will appear;

b) Modifications: The work is approved, but modifications not included in the initial instructions are needed. The further modifications will be treated as a new order. This button will take the Customer to the instruction module, with the image(s) viewed as the loaded images. Further instructions will be entered. The Provider will manually price these instructions and approval must be obtained;

c) Download: Allows the Customer to download the high-resolution image to view in more detail; or

d) My Project Manager: Additional work needs to be done on this image to comply with the original instructions and meet the Customer's satisfaction. The Customer will enter in comments on what needs to be done on the “Comments on Draft” interface.

If the Customer wishes to provide feedback on the project, he will be returned to the interface screen of FIG. 1, with the edited picture being displayed. Preferably, the Customer writes exactly what needs to be done or improved in the image. These comments will go to the Project Manager. The Project Manager will notify the Customer directly if further clarification is needed. When the comments are mutually understood, the comments will be sent to the Editor. If necessary or helpful, comments will be transmitted using the tools available through the instruction module

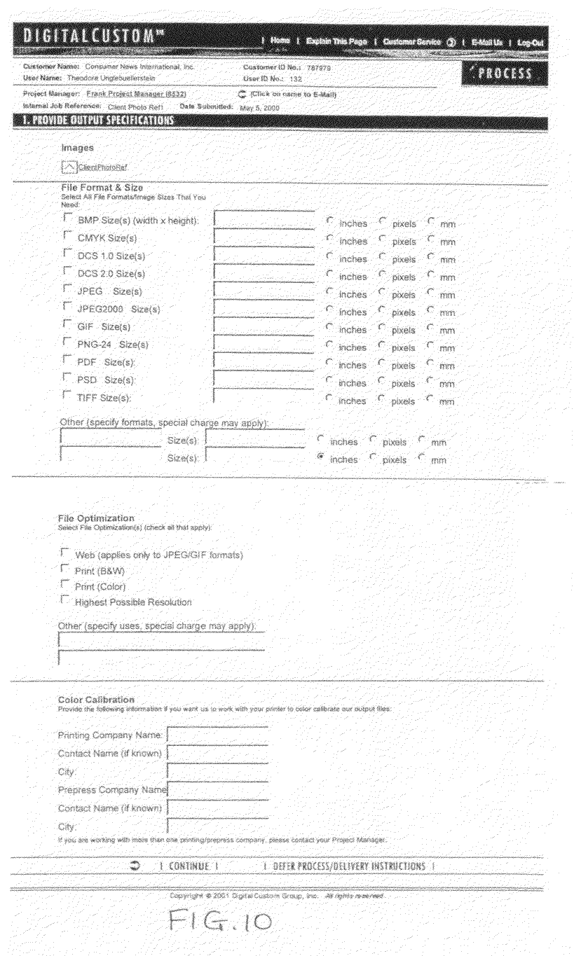

FIG. 10 illustrates the interface related to delivery instructions. This interface enables the Customer to select among various delivery options. The choices include different file formats, file optimization for different media, color calibration for printing and more, and delivery of the file(s) on different storage devices.

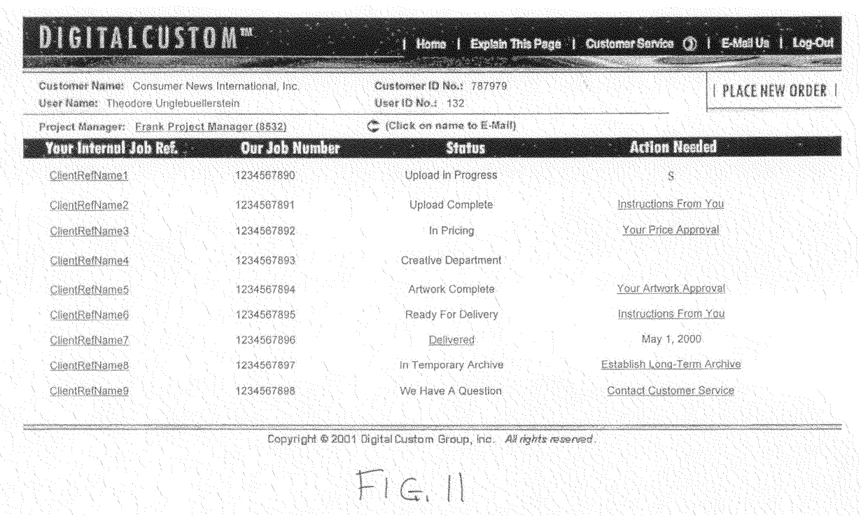

FIG. 11 is an illustration of the status check interface. This interface enables the Customer to view all active projects in the system associated with their account. The interface shows the Customer's job reference number “Your Internal Job Ref.”, the system's job number, “Our Job Number”, the status of the project, and action that needs to be taken by the Customer (if any).

Clicking on ajob hyperlink will bring the Customer to the “View Job Instructions” interface. Clicking on any “Action Needed” field will bring the Customer to the interface where the action can be done. The links include:

| | |
|---|---|
| “Instructions From You” | The Instruction Module |
| “Your Price Approval” | Choose Price |
| “Your Artwork Approval” | Approve Work |
| “Instructions From You” | Processing and Delivery Instructions |
| “Establish Long Term Archive” | Establish Long Term Archive |
| “Contact Customer Service” | Contact Customer Service |
| “Contact Your Project Manager” | Contact Your Project Manager |

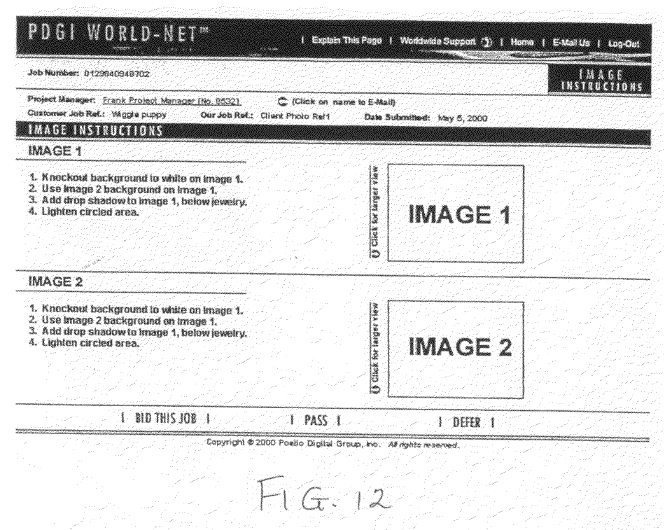

FIG. 12 illustrates the interface for displaying a summary of the inputted project instructions for the Customer to view and the Editor to bid or review. The interface contains the marked-up images in the Customer's order and a list of the text instructions next to each image to which the instructions apply. In the preferred embodiment, this screen is an HTML page that can be sent to many Editors. This format also facilitates the division of the project among a number of different Editors allowing for faster production and a higher degree of specialization.

Having described the basic flow structure and interfaces for the professional system, the consumer system will now be similarly described.

### Consumer System

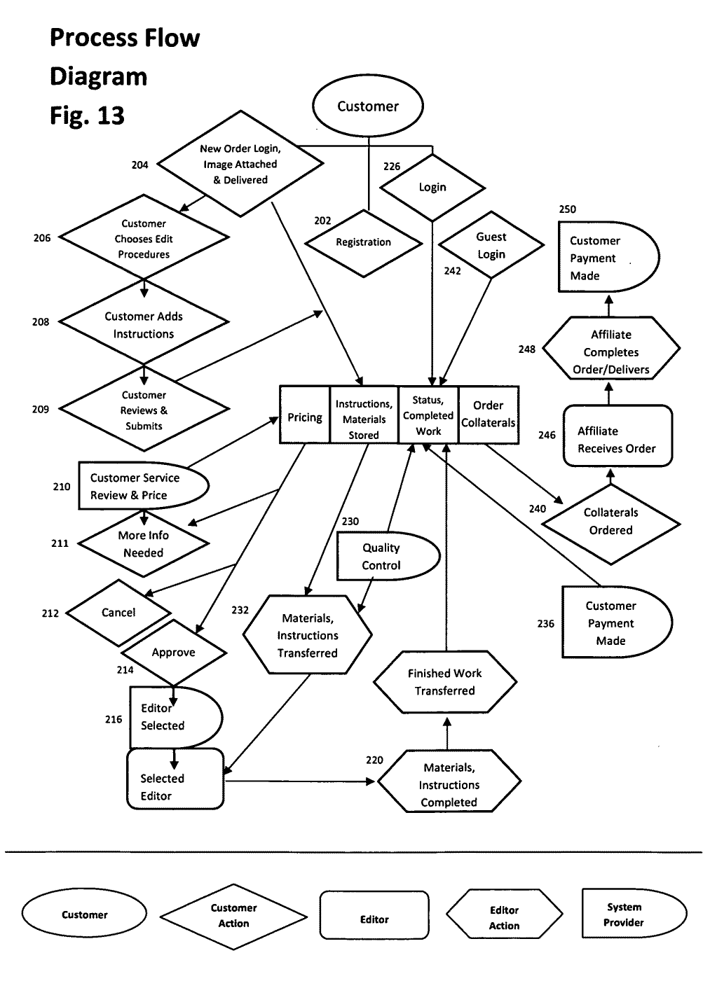

FIG. 13 is a flow diagram of consumer system. In this system, the Customer gains access using a computer, connected to a wide-area network (which may include, but is not limited to, what is commonly known as the “Internet”). A first time Customer will register by submitting personal information such as name, address, e-mail and password (step 202). Once registered, the Customer may initiate a “new order” for digital editing services.

The Customer enters login information, selects a digital image that resides on his or her local storage device to be edited (step 204). When the Customer submits the file and login information to the system the login is verified by matching the entered User id and password combination to a valid Customer's information. If the User and password combination is invalid, the User is alerted to this and the system does nothing further until a valid combination is entered. Otherwise, the selected file is transmitted from the Customer to the Provider and the Customer is brought to an instruction page with a list of procedures offered by the Provider to select from and a low-resolution display of the uploaded file (step 206). After selecting the desired procedure(s), the Customer is brought to a series of follow up questions that aide the Customer in describing the edits for the selected procedure and allow the Customer to input custom written instructions if necessary (step 208). The Customer reviews the order before final submission when the instruction information is transmitted into the system and tagged along with the original image for this order (step 209).

The completion of the order instruction process updates a database and database-generated “Order Status” display for the Provider and Customer to indicate the order is being reviewed and priced. The system organizes and prioritizes the instructions in an enumerated list according to principles of efficiency that are automated in the system.

Upon registration, the Customer must complete a “Policy Verification” stating they 1) are the photographer or owner of the picture, 2) are using the finished picture for non-commercial purposes, 3) agree to a Limited Warranty, 4) agree to an Intellectual Property Agreement and 5) agree to an Arbitration Agreement.

The order, if successfully placed, goes into a status indicating it needs to be reviewed and priced.

A Provider Representative logs in to the system to review and price the order (step 210). In this step, the instructions by the Customer are reviewed. If the instructions are sufficient to complete the order, the Representative prices the order. The base price is determined based on the complexity and amount of work. Additional prices are generated from the base price algorithmically where the price varies according to the turn around deadline. The order status is changed to indicate that Customer price approval is needed.

If the Representative needs additional information from the Customer in order to price the order, a notification is sent to the Customer (step 211). The order status is changed to indicate that Customer instruction revisions are needed.

If additional information is requested, the Customer must submit the requested information for the order to proceed. (The information is reviewed and the process continues.)

If the order is priced, the Customer is given the choice to accept one of the prices or decline the order. If declined, the order will be removed from the system (step 212). The order status is changed to indicate that the Customer did not accept the price. If one of the order prices is accepted (step 214), the Customer submits payment information to continue with the order. The order status is changed to indicate that editing (“artwork”) is in progress.

The system selects the Editor to fulfill the order requirements (step 216). The Editors are determined by: (1) matching the skill set of the Technician with Customer's order needs, and/or (2) by distributing orders according to a predetermined percentage. The Representative can override the automated recommendation and manually choose the best Editors for the job.

The selected Editor then receives all materials and instructions for the order (step 220). The materials and instructions are transmitted to the Editor from a private and secure source.

The selected Editor performs the digital editing in accordance to instructions provided and within a set deadline (step 222). The selected Editor transmits the completed work into the system. The return of materials updates a database and database-generated “Order Status” display for the Provider and Customer to indicate that the “Order” is complete and identified by the Provider Tag and the Customer Tag. The completion of work also triggers a notice to the Editor, summarizing the project and noting the amount payable. This information ultimately is transferred to accounts payable.

The Customer is notified that the “Order” is complete and is available through the system. The Customer is then prompted to enter the system through a new login window to view or pick-up their order (step 226).

The Editor has the option of tagging order to be reviewed by a Representative before the Customer is alerted. In this case, the Representative will review the work as part of quality control (step 230). The Representative will review the completed work to make sure all instructions were followed properly. If the finished work is satisfactory, the Customer is notified that the “Order” is complete and is available through the system. The Customer is then prompted to enter the system through the login as noted above. If the work is not satisfactory, it is returned to the Editor. Further instructions are added to help aid the Editor (step 232). Upon completion, the order goes through steps 220 and 222 again.

Upon completion of the job, the Customer is charged for the price agreed upon (step 236).

When the Customer logs back into the system he arrives at the Status page. The job status is updated as a result of certain events in the manner described above. Once in the system, the Customer can check the status of their order(s) at any time. If the order is finished, the image can be downloaded. The Customer is given the option to order collaterals of the completed work. If they choose to do so, they are prompted to go to step 240. Collateral items such as prints, enlargements, calendars, and cups can be ordered. Payment information is collected through a secure module. An order confirmation is sent to the Customer.

The Customer is also given the option to allow family or friends to view the completed image. If the Customer chooses this option, a contact information form is filled out and sent to each person. Each person chosen by the Customer to view the image receives a notification with directions on how to enter the system. These family or friends would enter using the Guest Login (step 242). Upon entering the system, the appointed persons can view the completed image and order collaterals.

Once a collateral order is received it can be transferred to an affiliate (i.e., a large scale photo-production facility) or fulfilled in-house. The information and the modified digital image are transferred to the affiliate in step 246. The Fulfillment Provider then completes the order and ships the collateral item to the Customer (step 248). The Customer is billed separately for any purchased collateral items (step 250).

### Further Details of the Consumer Interface

Having described the overall process and the primary interface for inputting instructions, additional features of the consumer interface will now be described.

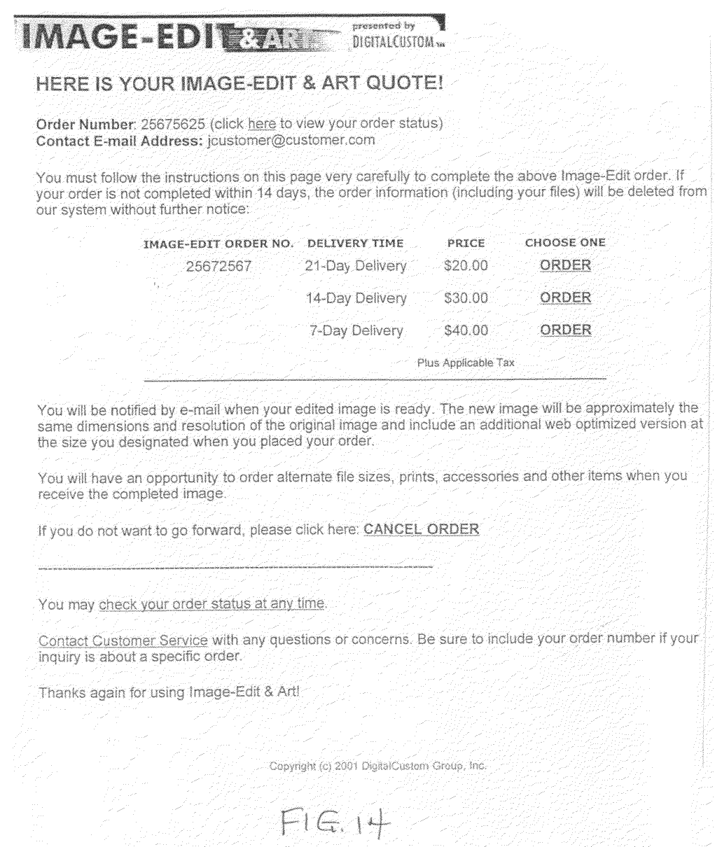

Assuming the Customer has completed the initial steps, including login, entering of instructions and uploading of the image and instructions to the Provider, the Provider (Representative) will generate a price quote. FIG. 14 illustrates the price quote screen. This page allows the Customer to accept or reject a price quote for a specific order. If the Customer wants to proceed he selects a price-delivery time combination and thereafter enters in payment information. Selecting “[Cancel Order]” and confirming this action will terminate the order for the Customer.

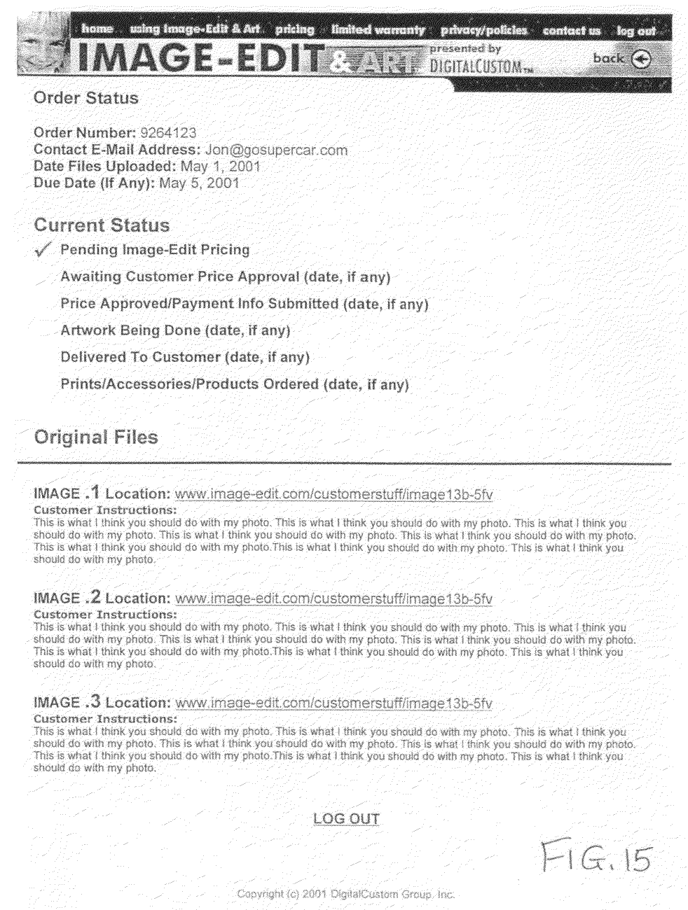

Once the order is placed, the Customer can review the order at any time in the future. FIG. 15 illustrates the order status page. This page displays the original uploaded images with the job instructions. The Customer may review any jobs associated with the Customer id for informational purposes. An Editor may view any active jobs associated with the Editor's id and download the original uploaded image(s).

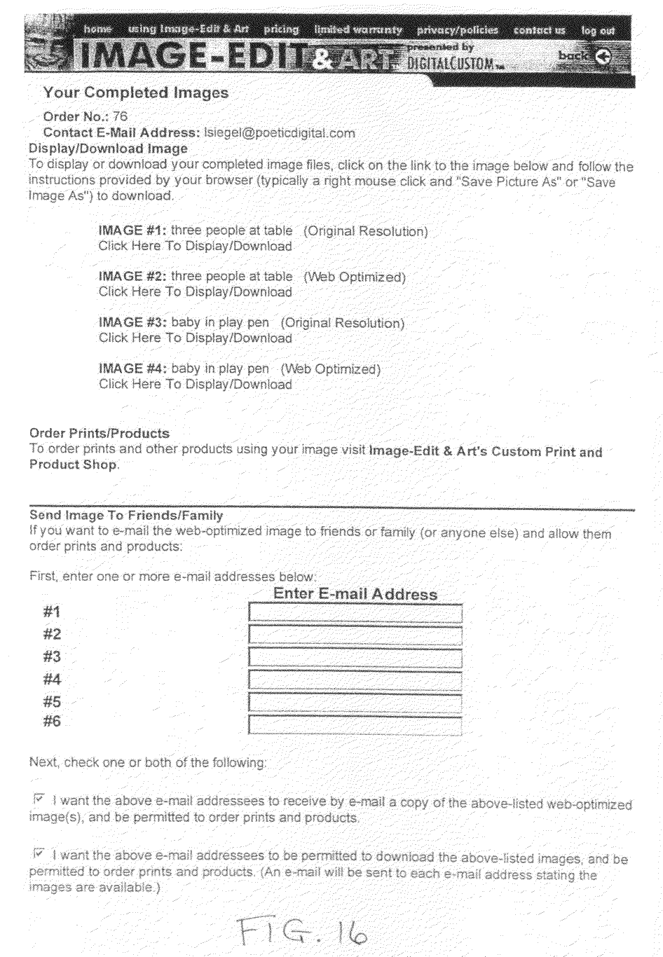

Once the job is completed, the Customer is notified by e-mail. The Customer may then go to a Completed Image Download Page, illustrated in FIG. 16. This page allows the Customer to download images, grant other emails addresses access to the completed images, or order prints and accessories.

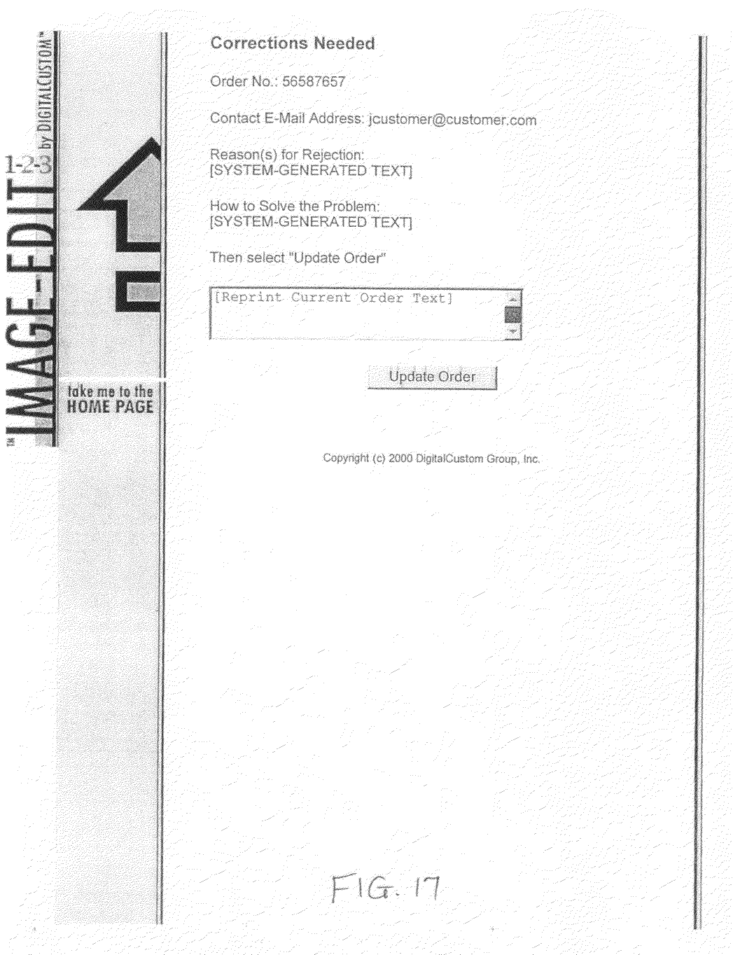

As noted above with respect to FIG. 13 and step 211, if the instructions entered by the Customer are insufficient to complete the order, the Customer is alerted and may supplement the instructions through the interface illustrated in FIG. 17. Once the instructions are supplemented, the Customer selects “update order” to transmit the corrected instructions into the system.

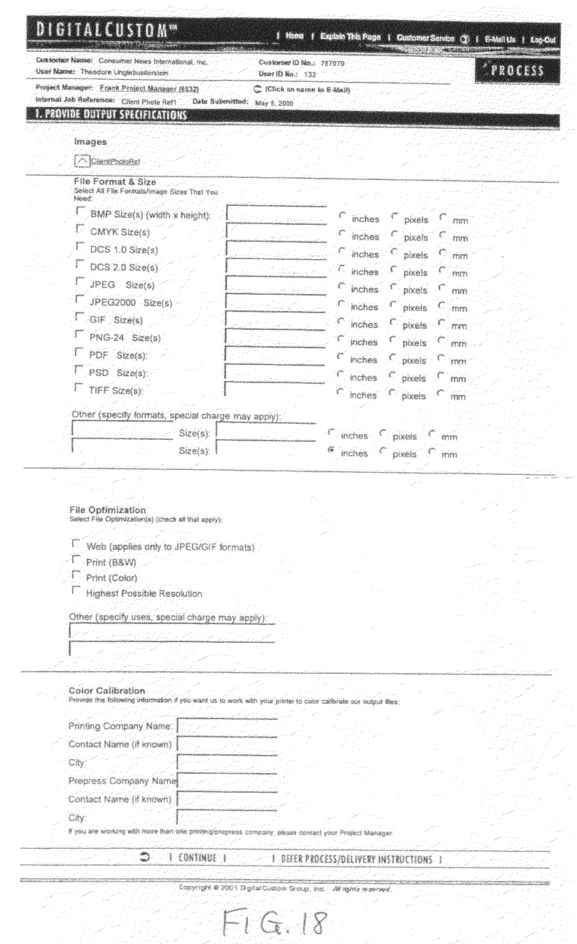

FIG. 18 illustrates a screen used by the Provider. This page allows the Provider's Representative to price the job or return the order to the Customer if incorrect instructions are submitted. The Representative is shown the first job available for review. The Representative must select a price, a reason for the insufficient instructions or reject the order on other grounds (e.g., obscenity).

By pressing “Submit and Review Next Job” the Representative is brought to the next job. By pressing “Submit and Exit” the Representative is exited out of the system. Upon reviewing/pricing the last job in the stage of the system, the Representative is returned to the Pricing/Order Review status page.

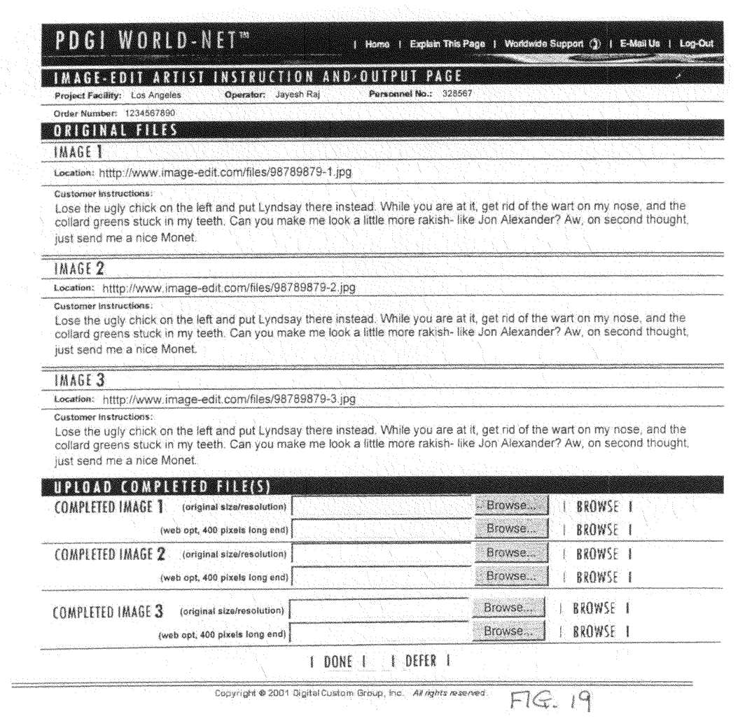

FIG. 19 illustrates a screen used by the Editor to transmit completed final image files from a local storage device to the Provider. All completed images must be uploaded at once. Once uploaded, the job will go into a completed status or it will go into quality control.

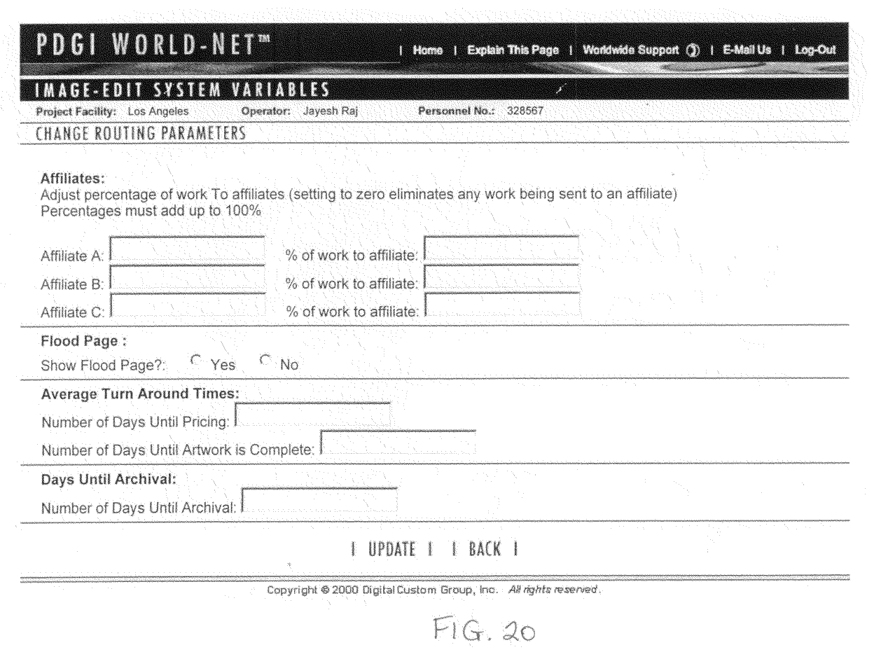

FIG. 20 illustrates a screen used by the Provider System Administrator to update many system variables that control the system workflow. Variables include:

1. The default percentage of jobs routed to the each Editor: The User can adjust the percentages of work going to each Editor. The system ensures the percentages sum to 100.

2. The flood page: this allows the System Administrator to alert Users to delayed turn around times before the User views the main interfaces.

3. The default pricing turn around time: this is the turn around time for the project as priced by the Pricing/Order Review Representative

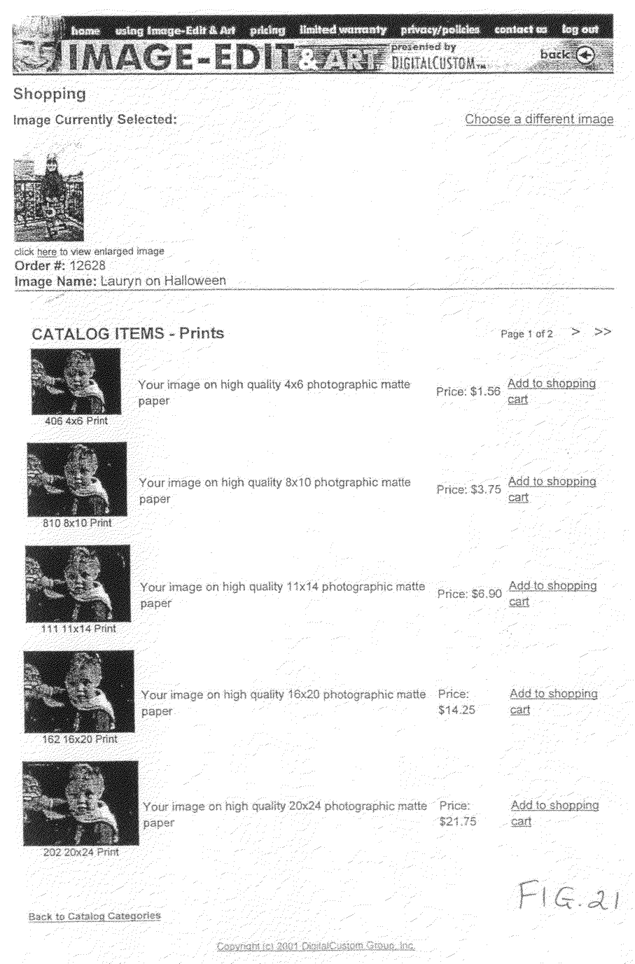

FIG. 21 illustrates illustrate an example of an image ordering page. This type of page presents the Customer with a variety of choices, in this instance various image sizes at different prices. The User may add his choices to the shopping cart.

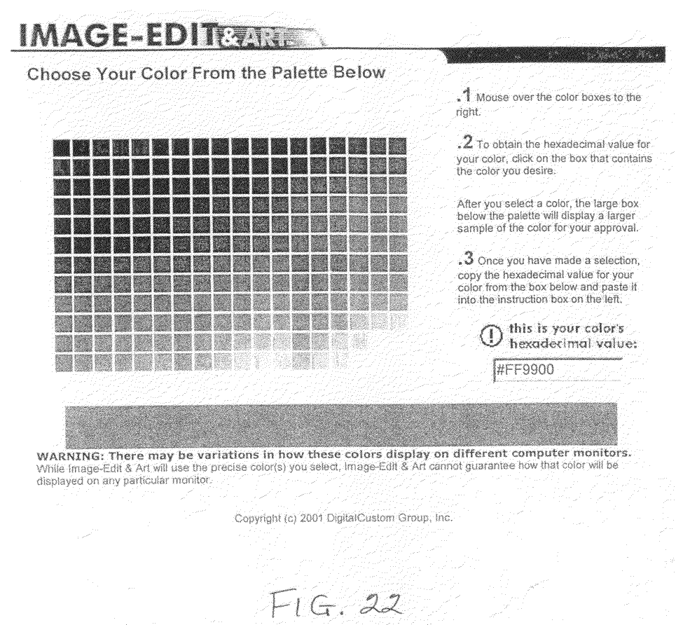

FIG. 22 illustrates a color palette page that may be used with the either the professional or consumer version. Using this color palette, the Customer can accurately identify a desired color. The palette colors conform to standardized colors and can be used by the Digital Artist to accurately make a suggested color change to a picture.

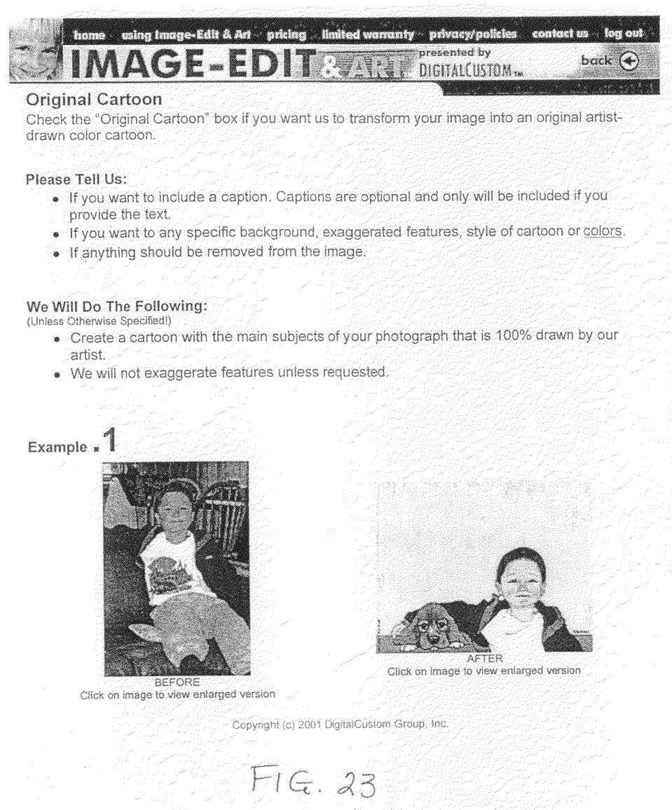

While most of the requested actions of a Customer require modifying an existing image, it should be noted that the subject interface can accommodate additional applications. For example, and as noted in FIG. 2, a Customer can request that an Editor create an original photo-illustration of the digital image. In this case, the Editor/Artist will create a photo-illustration based on the original digital image and manage the intake and delivery of the product through the system. The interface also allows the Customer to give specific instructions on the creation of the photo-illustration. An example of such a procedure is illustrated in FIG. 23.

It should also be understood that the modification of the digital image would include adding or merging one image with another.

### Alternative Consumer Embodiment

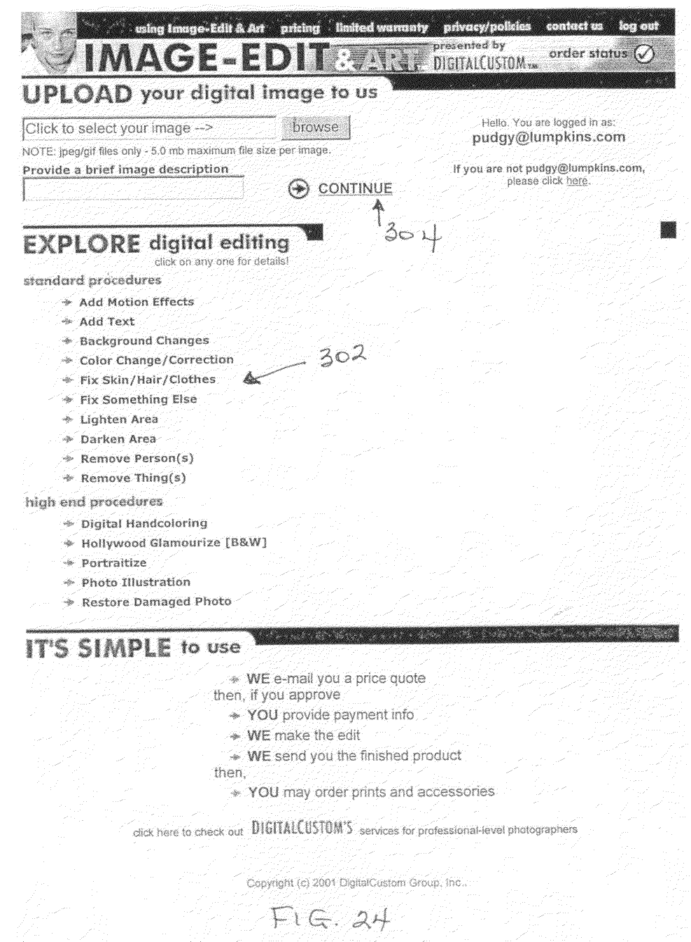

FIGS. 24-27 represent an alternate embodiment of the interface for a consumer application. The first embodiment, illustrated in FIG. 2, is designed to consolidate all of the principal information on a single page. The approach of FIG. 2 is desirable to minimize page-loading times. However, as consumer access to higher speed, broadband connections increases, the need to minimize the number of page downloads decreases. Accordingly, an interface approach can be designed that includes more pages, but is easier to understand and use.

FIG. 24 illustrates the first page of an interface that the Customer sees after a login procedure in accordance with this alternate embodiment. This page provides a list 302 of the various types of digital editing procedures that are available. The Customer may click on any of the procedures and be linked to a page describing this procedure. An example of a description page is seen in FIG. 3. Unlike the interface approach of FIG. 2, this first screen of FIG. 24 is not configured to accept instructions. Rather, the Customer must first move to the next screen by clicking on a “Continue” button 304.

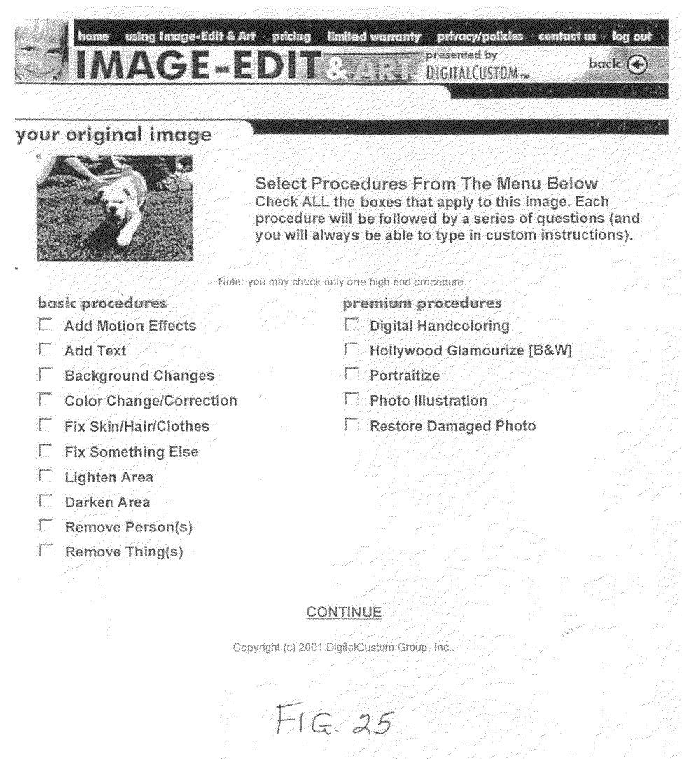

FIG. 25 illustrates the following screen where the Customer may select which procedures are to be performed on their image. The Customer may select one or more procedures. Following this selection, the Customer will be linked to a screen associated with one of the selected procedures. If more than one procedure is selected, the Customer will be serially linked to screens for each of the procedures.

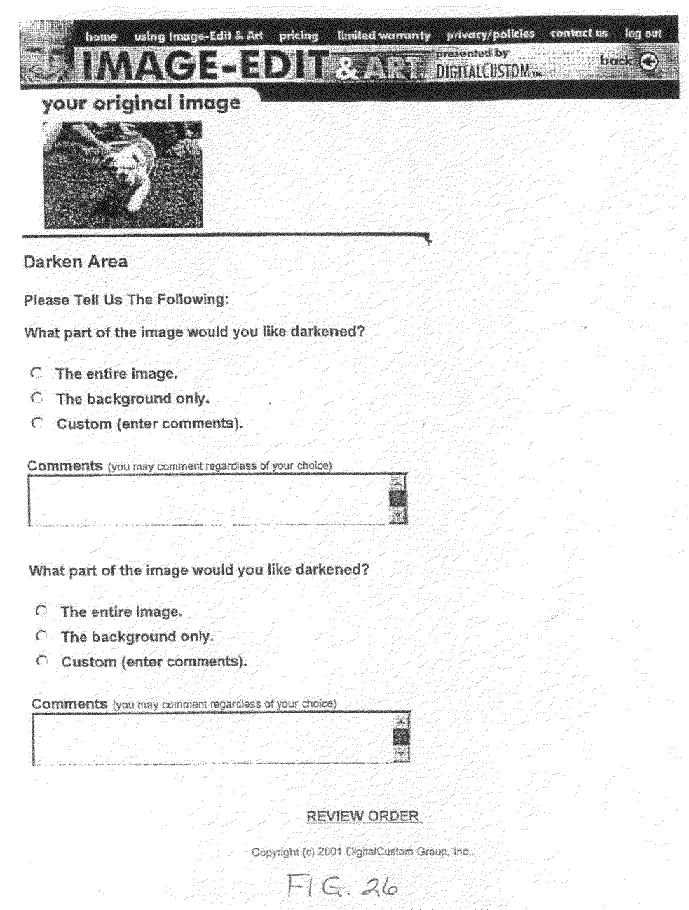

FIG. 26 illustrates one of the specific procedure instruction screens. Each of these screens will preferably include some basic questions that an Editor would need to know to perform the desired image manipulation. The use of such a question and answer format increases the likelihood that the Customer will be provided with the service that was actually desired. This screen also includes an area where the Customer may add additional comments.

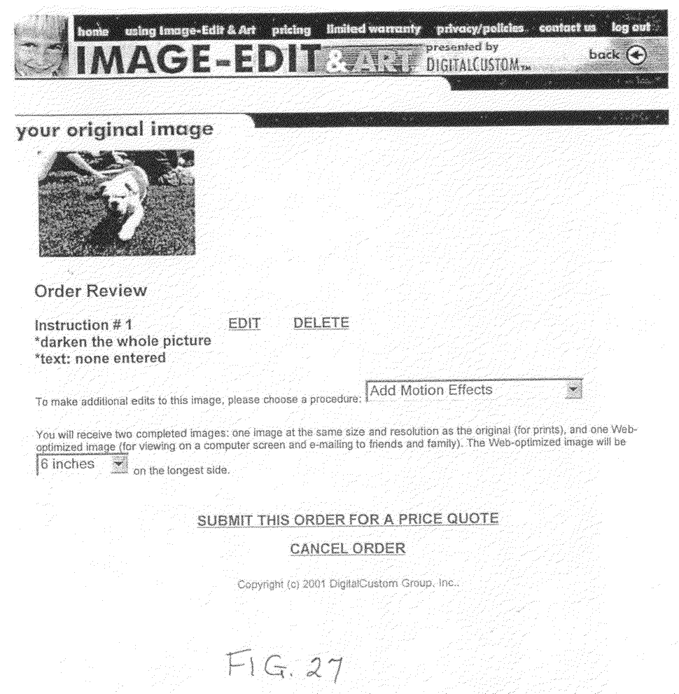

Once all the instructions have been entered, the Customer is brought to an Order Review screen as shown in FIG. 27. On this screen, the Customer will be shown the downloaded images along with all of the instructions that were entered. If the instructions are correct, the Customer can request a price quote for the job.

From this point, the procedures described above with respect to the first embodiment, (i.e., pricing, distributions to Editors, editing, approval and purchase) can be used.

### Other Applications for the Interface

While the subject interface is particularly suited to obtaining digital image editorial/artistic services from a geographically remote location, the ability of the interface platform to easily combine digital images and instructions related thereto for transmission over a network provides the opportunity to address other, more diverse applications.

For example, one can envision the early stages of an automotive design, where a design team is developing the appearance of a new vehicle. This design group can electronically transmit a digital image of that design over a network to a marketing department located in a geographically remote region. This marketing team could use an interface similar to the professional version discussed above to supply suggested changes in shape or color of the vehicle by marking the changes on the digital image. The information may be transmitted back to the design team for implementation. This process is enhanced by the fact that the subject invention converts an image and related text and graphical instructions, to a pervasive display language (such as Hypertext Markup Language). This allows for broad implementation of the system and worldwide collaboration.

In another example, the product being designed has progressed to a real, three-dimensional workpiece. The design team could capture a digital photograph of the workpiece and electronically transfer it to a remote fabricator. The fabricator could use the interface to mark suggested changes to the workpiece on the digital image. This information could be transmitted back to the design team for implementation. Such a scenario could be used in the fashion industry for developing clothes, in the design, manufacture and marketing of industrial goods, and in the design, manufacture and marketing of consumer goods.

While the subject invention has been described with reference to a preferred embodiment, various changes and modifications could be made therein, by one skilled in the art, without varying from the scope and spirit of the subject invention as defined by the appended claims.

We claim:

1. A user interface allowing a holder of a digital image to input instructions of how the image should be modified by an editor, said interface comprising:
a region for displaying a rendering of the digital image;
a region for inputting textual instructions; and
an electronic drawing tool for adding electronic marks to the rendered digital image to indicate the location and/or type of modifications to be made.

2. An interface as recited in claim 1, further including a selection of electronic shortcuts corresponding to conventional image manipulation instructions.

3. An interface as recited in claim 2, wherein the shortcuts are combined with additional textual instructions.

4. An interface as recited in claim 1, including an algorithm for prioritizing the instructions based on efficiency.

5. An interface as recited in claim 1, wherein said electronic drawing tool is selected from the group consisting of a pencil, a stamp, an arrow and a boundary marker.

6. A user interface allowing a holder of a digital image to input instructions of how the image should be modified by an editor, said interface comprising:
a region displaying a list of selectable editing requests; and
a region for inputting textual instructions for supplementing a selected editing request.

7. An interface as recited in claim 6, wherein at least some of the selectable editing requests are linked to more detailed editing requests so that if a particular request is selected, the user will be prompted to provide additional information.

8. An interface as recited in claim 6, wherein at least some of the selectable editing requests are linking to text and images which illustrate the nature of the editing request.

9. A user interface allowing a holder of a digital image to input instructions of how the image should be modified by an editor, said interface comprising:
a region displaying a list of selectable editing requests, each such request providing a link to an associated display page related to that editing request; and
a plurality of display pages related to the selectable editing requests, said display pages including questions related to the request and a region for inputting textual instructions for supplementing the editing requests.

10. An interface as recited in claim 9, wherein at least some of the selectable editing requests are linked to a separate page with text and images that illustrate the nature of the editing request.
